(19) United States
(12) Patent Application Publication
(10) Pub. No.: US 2019/0141366 A1
(43) Pub. Date: May 9, 2019

(54) SYSTEM AND METHOD FOR INSERTION OF AN ASSET INTO A SOURCE DYNAMIC MEDIA

(71) Applicant: TINY PIXELS TECHNOLOGIES INC., Vancouver (CA)

(72) Inventors: June Yan Lin CHEN, Richmond (CA); Hsiehyu FUH, Palo Alto, CA (US)

(21) Appl. No.: 16/117,174

(22) Filed: Aug. 30, 2018

Related U.S. Application Data
(60) Provisional application No. 62/553,378, filed on Sep. 1, 2017.

(51) Int. Cl. H04N 21/234; H04N 21/2343; H04N 21/235; H04N 21/81

(52) U.S. Cl. CPC H04N 21/23424; H04N 21/234327; H04N 21/8146; H04N 21/812; H04N 21/2355

(57) ABSTRACT

A system and method for insertion of one or more advertisement assets into a source dynamic video. The method includes: determining a media format of each of the one or more advertisement assets; converting each of the media formats for each of the one or more advertisement assets for compatibility with a dynamic media format of the source dynamic media; selecting a portion of a timeline of the source dynamic media for each of the advertisement assets; blending the one or more advertisement assets into the source dynamic media during the respective determined portion of the timeline; encoding the source media and the blended one or more advertisement assets as a combined dynamic media; and outputting the combined dynamic media.

### TECHNICAL FIELD

The following relates generally to media processing, and more specifically, to a system and method for insertion of an asset into a source dynamic media.

### BACKGROUND

Playback of video content over the internet or other networks, whether streamed or downloaded, has become ubiquitous.

An important source of revenue for content hosting sites, content providers, content creators, and the like, is the ability to display advertisements in association with dynamic media content (referred to herein as the “source dynamic media”).

In some cases, advertisements in association with such media can include pre-roll, mid-roll or post-roll advertisements. In these cases, the video content is interrupted at the beginning, middle, or end, respectively, of playback to play or display an advertisement. This type of advertising is similar to commercial breaks in traditional television programming.

In other cases, advertisements can include banner advertisements. In these cases, graphical advertising elements are set outside the frame of the source media, or overlaid as an additional element over the media frame (typically positioned along the bottom of the frame). In some cases, such advertisements are occluded when the media is shown in full screen mode.

It is therefore an object of the present invention to provide a system and method in which the above disadvantages are obviated or mitigated and attainment of beneficial aspects are facilitated.

### SUMMARY

In an aspect, there is provided a method for automated insertion of one or more assets into a source dynamic media, the method executed on at least one processing unit, the method comprising: receiving the source dynamic media, the source dynamic media having an associated timeline; receiving the one or more assets; determining a media format of each of the one or more assets, the media format comprising at least one of a video component, an audio component, a coded-page component, a text component, and an image component; converting each of the media formats for each of the one or more assets for compatibility with a dynamic media format of the source dynamic media; selecting a portion of the timeline for each of the assets; blending the one or more assets into the source dynamic media during the respective determined portion of the timeline; encoding the source media and the blended one or more assets as a combined dynamic media; and outputting the combined dynamic media.

In a particular case, where the media format comprises a coded-page component, the converting of the media format comprises frame-by-frame conversion into a red green blue alpha (RGBA) format, the alpha channel comprising transparency characteristics.

In another case, the frame-by-frame conversion into the red green blue alpha (RGBA) format comprises: loading the coded-page in a browser; operating the browser with a headless configuration in a virtual window; repeatedly capturing a RGBA image of at least a portion of the elements in the virtual window at a predetermined framerate with any transparent elements captured in the alpha channel; and saving the RGBA images sequentially as a video file.

In yet another case, the coded-page comprises at least one of Hypertext Mark-up Language (HTML), Cascading Style Sheets (CSS), JavaScript, and WebGL.

In yet another case, where the media format of one of the assets comprises a video component, a coded-page component, a text component, or an image component, the method further comprising selecting a screen position for such asset relative to the source dynamic media.

In yet another case, encoding the source media and the blended one or more assets as the combined dynamic media comprises applying FFMPEG encoding to the source media and the blended one or more assets using a filter graph.

In yet another case, blending the one or more assets into the source dynamic media comprises overlaying each of the one or more assets over the source dynamic media at the selected portion of the timeline.

In yet another case, where the media format of one of the assets comprises an audio component, overlaying such audio component over the audio of the dynamic media.

In yet another case, blending the one or more assets into the source dynamic media comprises interspersing each of the one or more assets between portions of the timeline of a corresponding media format of the source dynamic media.

In yet another case, the one or more assets comprise two or more assets, and wherein overlaying the assets over the source dynamic media comprises: organizing the assets into a plurality of layers, each layer comprising one or more assets; assigning a layer order to the plurality of layers; and overlaying the assets over the source dynamic media in an order that is based on the layer order.

In another aspect, there is provided a system for automated insertion of one or more assets into a source dynamic media, the system comprising at least one processing unit and a data storage, the at least one processing unit in communication with the data storage and configured to execute: an obtainment module to receive into the data storage the source dynamic media, the source dynamic media having an associated timeline, and receive into the data storage the one or more assets; a coding module to determine a media format of each of the one or more assets, the media format comprising at least one of a video component, an audio component, a coded-page component, a text component, and an image component, and convert each of the media formats for each of the one or more assets for compatibility with a dynamic media format of the source dynamic media; and an output module to select a portion of the timeline for each of the assets, blend the one or more assets into the source dynamic media during the respective determined portion of the timeline, encode the source media and the blended one or more assets as a combined dynamic media, and output the combined dynamic media.

In a particular case, where the media format comprises a coded-page component, the converting of the media format comprises frame-by-frame conversion into a red green blue alpha (RGBA) format, the alpha channel comprising transparency characteristics.

In another case, the frame-by-frame conversion into the red green blue alpha (RGBA) format comprises: loading the coded-page in a browser; operating the browser with a headless configuration in a virtual window; repeatedly capturing a RGBA image of the virtual window at a predetermined framerate with any transparent elements captured in the alpha channel; and saving the RGBA images sequentially as a video file.

In yet another case, the coded-page comprises at least one of Hypertext Mark-up Language (HTML), Cascading Style Sheets (CSS), JavaScript, and WebGL.

In yet another case, where the media format of one of the assets comprises a video component, a coded-page component, a text component, or an image component, the output module further selects a screen position for such asset relative to the source dynamic media.

In yet another case, encoding the source media and the blended one or more assets as the combined dynamic media comprises applying FFMPEG encoding to the source media and the blended one or more assets using a filter graph.

In yet another case, blending the one or more assets into the source dynamic media comprises overlaying each of the one or more assets over the source dynamic media at the selected portion of the timeline.

In yet another case, where the media format of one of the assets comprises an audio component, overlaying such audio component over the audio of the dynamic media.

In yet another case, blending the one or more assets into the source dynamic media comprises interspersing each of the one or more assets between portions of the timeline of a corresponding media format of the source dynamic media.

In yet another case, the one or more assets comprise two or more assets, and wherein overlaying the assets over the source dynamic media comprises: organizing the assets into a plurality of layers, each layer comprising one or more assets; assigning a layer order to the plurality of layers; and overlaying the assets over the source dynamic media in an order that is based on the layer order.

These and other embodiments are contemplated and described herein. It will be appreciated that the foregoing summary sets out representative aspects of systems and methods for automated overlay insertion to assist skilled readers in understanding the following detailed description.

### BRIEF DESCRIPTION OF THE DRAWINGS

The features of the invention will become more apparent in the following detailed description in which reference is made to the appended drawings wherein:

FIG. 1 is a schematic diagram of a system for insertion of an advertisement into a video, in accordance with an embodiment;

FIG. 2 is a schematic diagram showing the system of FIG. 1 and an exemplary operating environment;

FIG. 3 is a flow chart of a method for insertion of an advertisement into a video, in accordance with an embodiment;

FIG. 4 is an exemplary high-level architectural diagram of the system of FIG. 1;

FIG. 5 illustrates an exemplary data flow approach for rendering of a combined source dynamic media and advertisement;

FIG. 6 illustrates a frame of a video with an inserted advertisement, according to the system of FIG. 1;

FIG. 7A illustrates an exemplary diagrammatic program flow; and

FIG. 7B illustrates an exemplary diagrammatic job.

### DETAILED DESCRIPTION

Embodiments will now be described with reference to the figures. For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Any module, unit, component, server, computer, terminal, engine or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

The following disclosure relates generally to video processing; and more specifically, to a system and method for insertion of an advertisement into a video.

For some approaches to advertisement in association with dynamic media, they may require that there be no video, or dynamic, advertisements during playback of the source media. Conventional approaches to inserting advertisements during playback of a video typically includes: receiving a source dynamic media into a video editing software; receiving an advertisement as media (video or image files) into the video editing software; manually selecting and placing the advertisement's on-screen position and selecting the time of placement within the source dynamic media; and exporting the combined video to a content provider or otherwise distributing the combined video.

Previous approaches can be cost prohibitive on any type of medium to large scale, and particularly so where there is a large number of videos and advertisements. Such approaches can also be time prohibitive, as producing the combined videos takes a user's time, in the order of minutes, which is prohibitive when there are a multitude of videos or advertisements. Such approaches can also be error prone when advertisements, with many parts or images, are required to be inserted with precision in terms of position and time. Such approaches can also be unable to insert dynamically generated advertisement overlays that require code execution at the time of insertion.

Advantageously, as described herein, the present embodiments allow for advertisement assets to be used in association with source dynamic media that have dynamic media, or are generally dynamic, during playback of the source dynamic media. Additionally, the present embodiments advantageously permit dynamic advertisement assets to be transparently blended into the source dynamic media. Further, the present embodiments advantageously permit advertisement assets that are generally not at risk of being removed by ad-blocking software.

Applicant has recognized the substantial advantages of the embodiments described herein. As an example of such an advantage, a system is provided which can insert advertisements in a source dynamic media to produce a merged or united dynamic media with the advertisement inserted into the source dynamic media. As a further example of such an advantage, a system is provided to incorporate assets, for example, media, images and HTML documents, which form an advertisement, into a dynamic media source. As a further example of such an advantage, a system is provided which automatically allocates metadata to the advertisement in order to match against a source dynamic media. As a further example of such an advantage, a system is provided which is flexible to accept rules for matching of an advertisement to a source dynamic media; in some cases, including the on-screen position, timeline position and duration of where the advertisement is to be incorporated into the source dynamic media. As a further example of such an advantage, a system is provided which has advertisements, associated with dynamic media content, that are generally not effectively blockable by ad blocking software due to being essentially part of the source dynamic media. As a further example of such an advantage, a system is provided which has advertisements that contain, or is customizable via, HTML (Hypertext Markup Language) code; allowing each advertisement to have a different visual or audio output. As a further example of such an advantage, a system is provided which has insertion of advertisements in a way that is generally more efficient and scalable than manual insertion of advertisements.

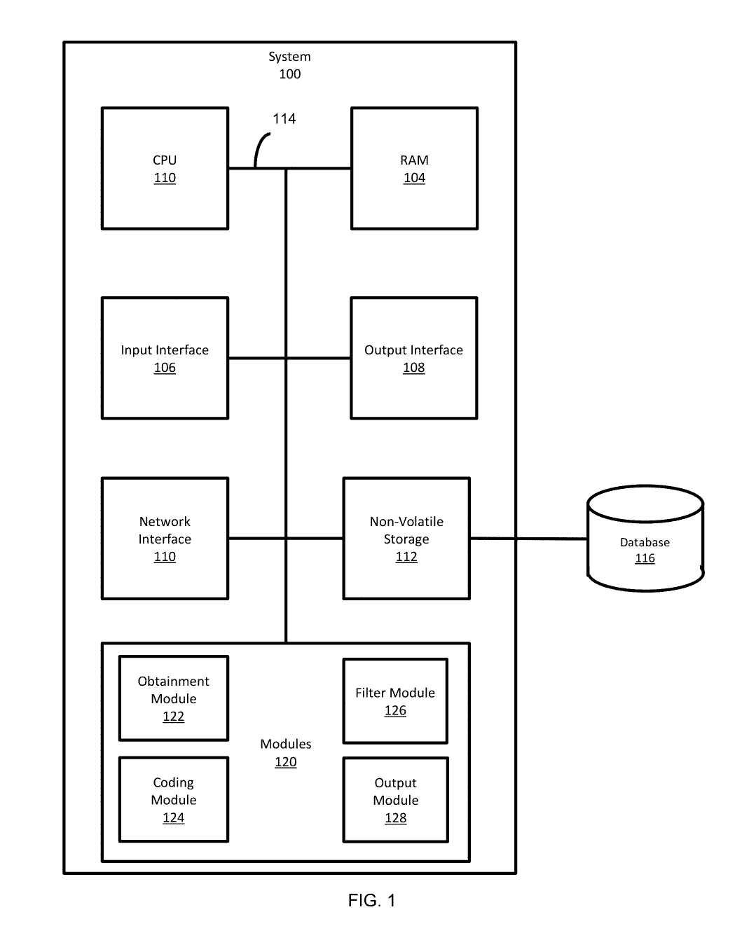

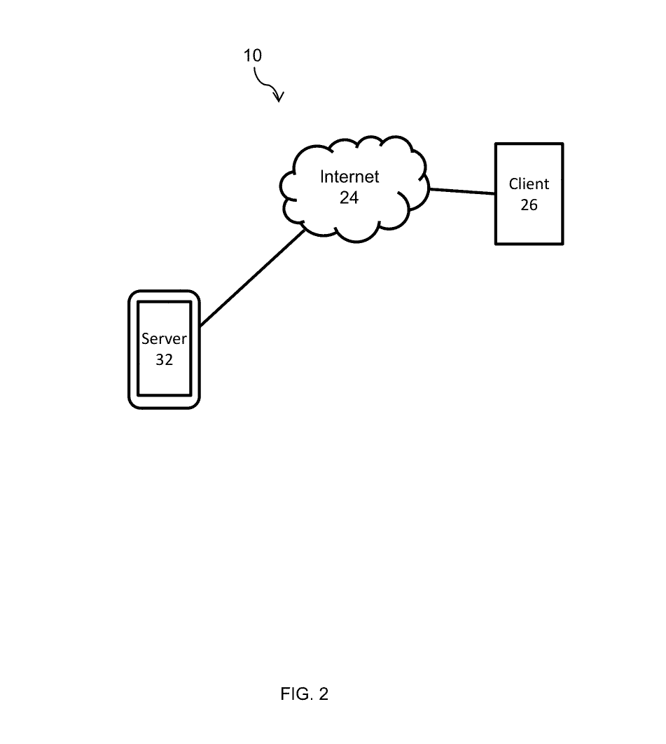

Referring now to FIG. 1, a system 100 for insertion of an advertisement into a dynamic media, in accordance with an embodiment, is shown. In this embodiment, the system 100 is run on a server (32 in FIG. 2). In further embodiments, the system 100 can be run on any other computing device; for example, a desktop computer, a laptop computer, a smartphone, a tablet computer, a point-of-sale (“PoS”) device, a smartwatch, or the like. In this case, the system 100 is run on the server (32 in FIG. 2) and accessed by a client device (26 in FIG. 2) having an input interface 106 permitting a user to input parameters and/or manage system functions.

FIG. 1 shows various physical and logical components of an embodiment of the system 100. In a particular case, the system 100 can be a server-side computing device 32 (as shown in FIG. 2). As shown, the system 100 has a number of physical and logical components, including a central processing unit (“CPU”) 102, random access memory (“RAM”) 104, the input interface 106, an output interface 108, a network interface 110, non-volatile storage 112, and a local bus 114 enabling CPU 102 to communicate with the other components. CPU 102 executes an operating system, and various modules 120, as described below in greater detail. RAM 104 provides relatively responsive volatile storage to CPU 102. The input interface 106 enables an administrator or user to provide input via an input device, for example a keyboard and mouse. The output interface 108 outputs information to output devices, such as a display and/or speakers. The network interface 110 permits communication with other systems, such as other computing devices and servers remotely located from the system 100, such as for a typical cloud-based access model. Non-volatile storage 112 stores the operating system and programs, including computer-executable instructions for implementing the operating system and modules, as well as any data used by these services. Additional stored data, as described below, can be stored in a database 116. During operation of the system 100, the operating system, the modules, and the related data may be retrieved from the non-volatile storage 112 and placed in RAM 104 to facilitate execution. In various embodiments, the system comprises a web accessible API, such as a REST API, for facilitating access by the user at the client device to server functionality, including the various modules. The job queue created in the API server can be handled by the CPU or distributed, for example among scalable on-demand GPU cloud computing servers.

In an embodiment, as described in more detail in the following, the system 100 includes various modules 120; including an obtainment module 122, a coding module 124, a filter module 126 and an output module 128.

In some cases, as shown in a diagram of a computing environment 10 in FIG. 2, the system 100 can communicate with, and retrieve data, from other computing devices; for example, from a client computing device 26 to the server 32. The system can communicate with these devices over a data communication network; for example, the Internet 24.

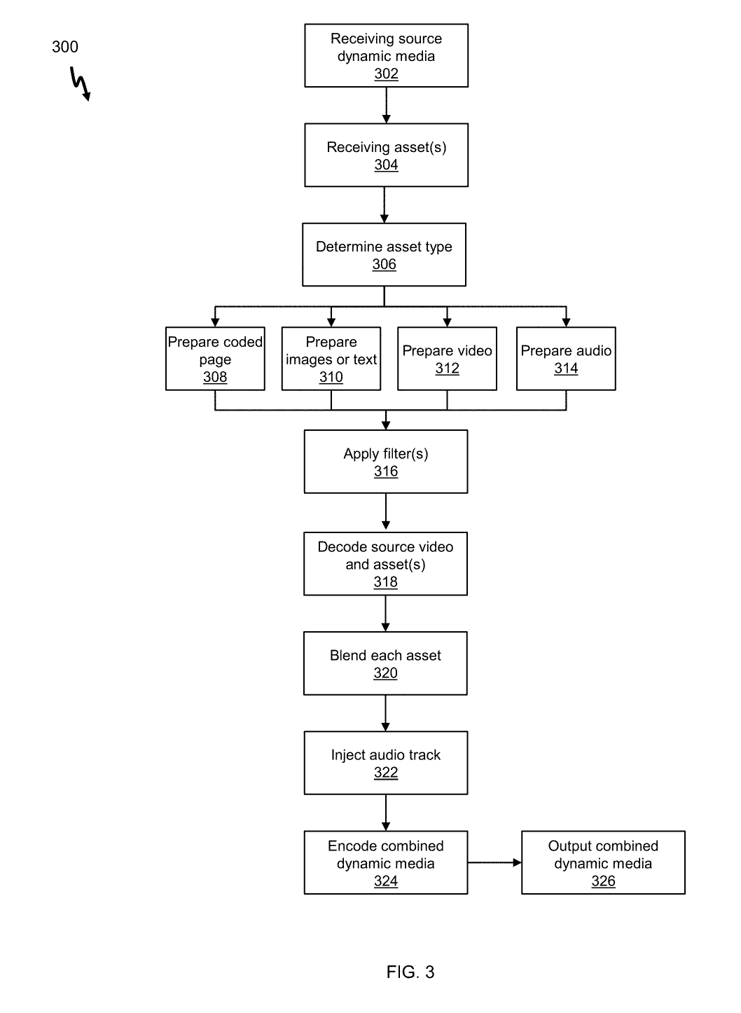

Referring to FIG. 3, a method 300 for insertion of an advertisement into a dynamic media, in accordance with an embodiment, is shown.

At block 302, receiving, by the obtainment module 122, a source dynamic media, animation, dynamic image, or other type of dynamic media having a duration. At block 304, receiving by the obtainment module 122, one or more assets. The assets can have one or more media formats; for example, videos, images, audio, text, coded pages (such as HTML documents), or the like.

At block 306, the coding module 124 determines the media format components (type of media) of the asset.

At block 308, where the asset comprises a dynamic element on a coded page (for example, an HTML, Cascading Style Sheets (CSS), Javascript, or WebGL coded page), the coding module 124 converts the page to a red green blue alpha (RGBA) pixel format, via frame-by-frame conversion. In a particular case, the frame-by-frame conversion is at a 30 frames-per-second rate. The RGBA pixel format is a frame composed of per pixel RGB color space with alpha channel to preserve the transparency characteristics.

At block 310, where the asset comprises one or more images or text blocks, the coding module 124 prepares the image or text blocks for insertion into the source dynamic media. Insertion can involve overlaying each of the images or text blocks on one or more frames of the source dynamic media.

At block 312, where the asset comprises a video, animation, or dynamic image, or is already alpha-channel enabled (for example, webm), the coding module 124 prepares the video for insertion. Insertion can involve displaying the video, animation, or dynamic image overlaid, interspersed, or alongside, the source dynamic media.

The coding module 124 can define how the asset is to be merged with respect to the dynamic source media, for both the screen location relative to the dynamic source media and relative to the timeline of the dynamic source media. In an example, consider a dynamic media to be a sequence of image frames at a certain frame rate. For example, most video is at 24˜30 fps (frame per second), each frame being an individual image. The process of blending the source dynamic media frame image with the asset's frame image can be by synchronizing each other's presentation timeline. In some cases, during the blending process, the asset can be placed at any screen location relative to the source dynamic media's frame. In further cases, the asset can change its screen location, along the timeline, relative to the source dynamic media frame. In an example, the system 100 can overlay a 15 fps, 10 seconds long asset at the top left corner of a 30 fps, 2 minutes long source dynamic media at the 1 minute mark of the timeline, and gradually move the asset out of the source dynamic media's frame starting from the left side of the screen. This example will generally involve decoding both the source dynamic media and asset to individual frames:
source dynamic media: 30*2*60=3600 frames, each frame will show for 1/30 seconds; and
asset: 15*10=150 frames, each frame will show for 1/15 seconds.

In this example, the blending of the first individual frame will start at 30*1*60=1800th frame of the source dynamic media, the asset's frame will be placed at x=0, y=0 location of the source dynamic media frame. Every asset's frame will be duplicated for every 2 frames of the source dynamic media, since the source dynamic media's frame rate is 2 times faster than the asset. At the same time, the location of the insertion will be changing from x=0, y=0 to x=−asset.width, y=0 during the 10 seconds period, clipping will occur when the x coordinate is negative. Thus, the asset will be displayed at the 1-minute mark of the source dynamic media at the top left corner and gradually move out of the source dynamic media frame from the left side in 10 seconds.

At block 314, where the asset comprises an audio track, the coding module 124 prepares the audio for insertion. Insertion can involve playing the audio track along with, or interspersed with, the audio channel of the source dynamic media.

At block 316, the filter module 126 applies a first filter to one or more of the assets in order to position, overlay and/or blend the asset to the source dynamic media. In some cases, the filter module 126 applies a second filter to align the asset to the proper location in the source dynamic media's timeline. The filter can be, for example, scaling, displacement of the assets, manipulation of color models, changing color tones, adding special effect (for example, creating mirror effect), adding histogram/waveform to the video, or the like. In a particular case, filtering can take place before the source dynamic media and assets are decoded to raw pixel format allowing the system to manipulate each frame at per pixel level.

At block 318, the output module 128 decodes the source dynamic media and each of the assets. At block 320, the output module 138 overlays and/or blends each asset into one or more frames of the source dynamic media, ensuring proper alignment with the source dynamic media's timeline. At block 322, if there is an audio track, the output module 128 plays the audio track along with, or overtop of, the audio channel of the source dynamic media, ensuring proper alignment with the source dynamic media's timeline.

The output module 128 can use any suitable decoder that can decode the video format to raw pixel data to one of the color space used by the codec. In most cases, the decoder can detect the container format and the codec used by the video and perform the decoding task. On other cases, for a decoder that cannot automatically detect the video format, the system could use the user interface to allow a user to indicate the format of the video and instruct the decoder to perform decoding task manually. Examples of decoders/tools can be FFMPEG, FLAC, Xvid, x264, or the like

At block 324, the output module 128 encodes a combined dynamic media comprising the source dynamic media inserted with the one or more assets. At block 326, the output module 128 outputs the combined dynamic media to, for example, the output interface 108, the network interface 110, or the database 116.

Generally, encoding involves taking raw pixel color data frames and performing video compression based on codec specification. With the blending and filtering having been applied to the assets and the source dynamic media, at a per-frame basis, the output module 128 encoder can take the sequence of frames and encode to the target codec format.

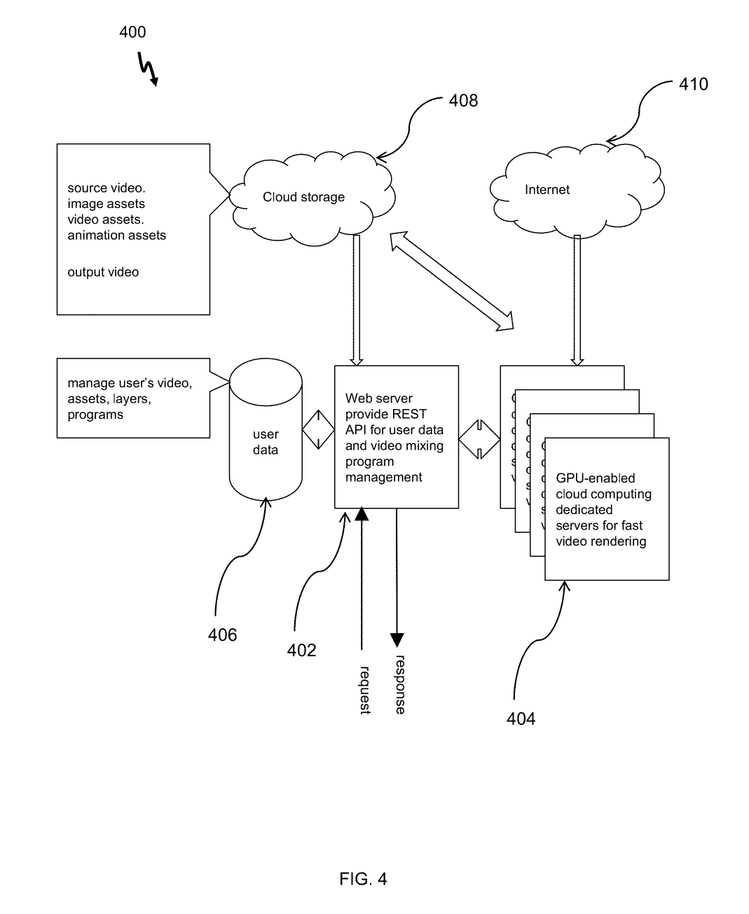

Referring to FIG. 4, an exemplary high-level architectural diagram of the embodiments described herein is shown. An API server 402 can act as a web server to provide an API to interface with user requests; as an example, to maintain user data and the method 300 given a source dynamic media and metadata. The source dynamic media can be of any suitable format, for example, MP4, FLV, WEBM, or the like. Once started, the data can be sent or otherwise offloaded to a GPU-enabled cloud computing service 404 to perform the dynamic media composition and rendering. The GPU-enabled cloud computing service 404 are GPU-enabled cloud computing servers with hardware acceleration capability to speed up dynamic media composition and rendering. User data can be stored in a specific database 406 which stores each user's settings (for example, workspace, program, layers, assets, video output profile, and job queue), and input and output location in a cloud storage 408. A job queue created in the API server can be distributed among the scalable on-demand GPU cloud computing servers 404, the source dynamic media, image assets, video assets, or animation assets can be pulled from cloud storage 408 or from the Internet 410. The output of the dynamic media composition can be stored in the cloud storage 408 as specified by the user via the REST APIs.

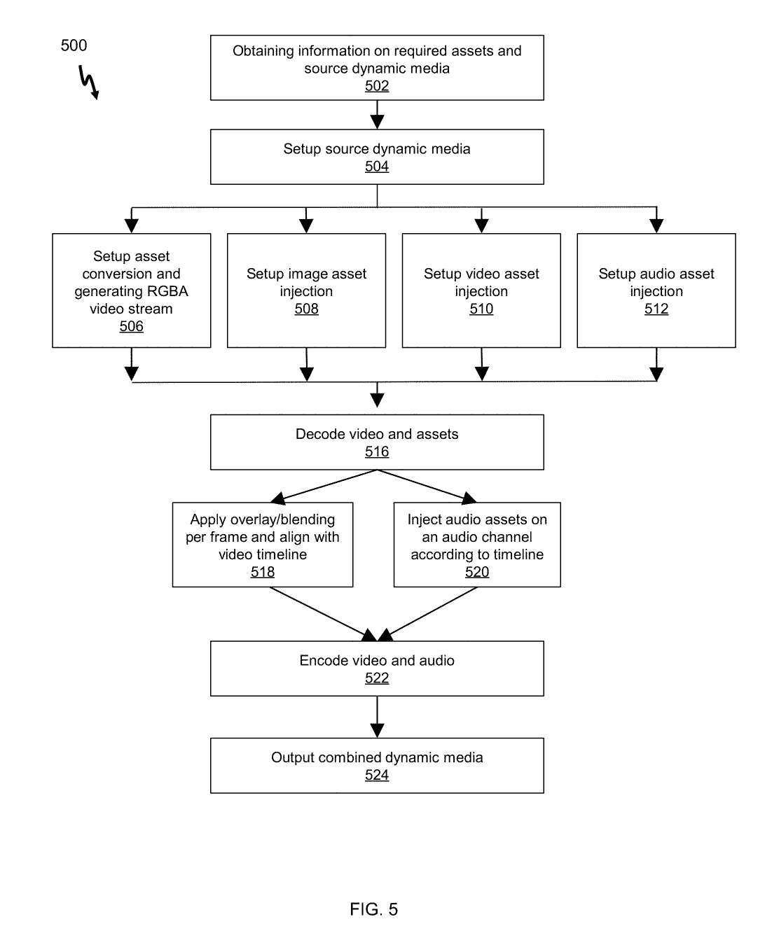

Referring to FIG. 5, an exemplary data flow approach 500 for rendering of a combined source dynamic media and advertisement, using the embodiments described herein, is shown. In this case, unlike conventional offline authoring tools (for example, Adobe™ After Effects™), insertion of a video advertisement into a source dynamic media is scalable and can be automated; for example, on a centralized server (such as a cloud service). In some cases, each job (as described herein) can be executed in parallel on a number of centralized servers.

At block 502, information is automatically gathered on one or more elements to be used in the advertisements incorporated with a source dynamic media (called “assets”). Information is also automatically gathered about the source dynamic media. As an example, each of the assets, and in some cases associated data, are received by the system. A location of each asset can be specified as a combination of source and asset path.

It is understood that an asset can include any suitable media component, data, file, coded page, or element. As an example, an asset can be a video file (with or without transparency), an image file, a text file, an audio file, a coded page (such as an HTML file, and associated files like other images, CSS markup, etc.), or the like.

In some cases, the system can gather parameters, for later use, about each asset; for example, width, height, duration, framerate, or the like. These parameters can be obtained from the file, or specified when the asset is created in an API.

In some cases, if an asset has unacceptable parameters, the system can return an error. As an example, the asset can be rejected if it has more than one video channel, has unsupported codecs (for example, not H264 or H265), too small of a picture size, or too low of a framerate (for example, less than 24 frames per second), or the like.

At block 504, the source dynamic media is automatically setup. As an example, the source dynamic media, and in some cases associated data, are received by the system. A location of the source dynamic media can be specified as a combination of source and video path.

In some cases, the system can gather parameters, for later use, about the source dynamic media; for example, for each video channel, a codec, a width, a height, a framerate, a duration, or the like.

In some cases, if the source dynamic media has unacceptable parameters, the system can return an error. As an example, the source dynamic media can be rejected if it has more than one video channel, unsupported codecs (for example, not H264 or H265), too small of a picture size, too low of a framerate (for example, less than 24 frames per second), or the like.

At blocks 506 to 512, each of the types of assets, if present, are setup by converting each of them to video format.

At block 506, if the asset is a coded page (for example, HTML, Cascading Style Sheets (CSS), Javascript, or WebGL coded page), the page is converted to RGBA pixel format, via frame-by-frame conversion at, for example, 30 frames-per-second. After conversion, the page can be treated by the system as another video. The RGBA pixel format is a frame composed of per pixel RGB color space with alpha channel to preserve the transparency characteristics.

To convert the coded page to RGBA format, a browser is run in headless configuration; for example, the browser is controlled programmatically without display to an output device. The browser API can be used to load the coded page (and in some cases associated files) and a snapshot image is captured of the coded page's virtual window run in the browser, repeatedly, at a predetermined framerate. Each snapshot image is taken as an RGBA image with a predetermined width and height. At least a portion of the visible elements of the coded page are captured in the snapshot image. If the coded page contains a transparent background or transparent elements, these transparent background and elements can also be captured in the RGBA snapshot image. The system saves the RGBA snapshot images sequentially into a data file; whereby such data file is a video file associated with the coded page asset.

At block 508, if the asset is one or more images, or is in text format, each of the images or text blocks are overlaid on one or more frames of the source dynamic media.

At block 510, if the asset is already in video format, or is already alpha-channel enabled (for example, webm), the asset is setup for insertion; including processing the information described above.

At block 512, if the asset is in audio format, or includes audio, the audio is setup for insertion; including processing the information described above.

In some cases, the setup assets can be stored in a temporary location for rendering.

At block 516, the source dynamic media and each of the assets are decoded.

At block 518, blending, including through overlay and/or interspersion, are applied for each asset per frame and are aligned with the source dynamic media timeline. For each asset, the system determines the start time, duration, size in width and height, start and end position, obtained from the setup of the asset, and determines a layer order. In a particular case, the blend type can be an “overlay”; this overlay can be based on layer order, where the lowest layer is the source dynamic media, followed by subsequent assets in higher layers. In this case, assets in higher layers may obscure those of lower layers. In some cases, for each layer, the system can also specify other common pixel blends; for example, multiply, brighten, darken, or the like. Each asset can be time aligned to the timeline of the source dynamic media by combining the start time and a timecode for each frame; whereby each frame in the video has an actual time offset from the beginning of the video.

At block 520, audio assets, if present, are inserted into the audio channel of the source dynamic media and aligned with the source dynamic media timeline. Similar to the video time alignment above, each audio “frame” or sample can have an actual time offset from the beginning of the video. This can be synchronized to an audio track's timecode of the source dynamic media.

At block 522, the video and audio are encoded into a combined video.

For blocks 516 to 522, a video decoder, overlayer, and encoder may be used. In an example, software such as FFMPEG may be used as the video decoder, overlayer, and encoder. In this case, parameters for each stage can be specified through an API and executed. As an example, FFMPEG can accept a number of input files and produce a number of output files. In this case, FFMPEG includes a protocol called a filter graph, which can be used to specify how, when, where, and which inputs are to be combined into a final media stream, and how the media stream should be output. For encoding, through the output object, parameters are obtained to instruct FFMPEG to write the media stream to one or more output media files, with specific video and audio codecs, and with specific parameters.

An advantage of using FFMPEG is that it can provide broad coverage of supporting codecs, it is generally highly customizable, and can provide hardware acceleration for decoding and encoding. Filter graph generally refers to the process of filter chaining as the flow of data is similar to a graph. In this way, the filter can perform pixel manipulation on a per-frame basis after the source dynamic media has been decoded into raw pixel color data. While the present embodiment is described with respect to FFMPEG, it should be understood that the system 100 shall not be limited to FFMPEG as any suitable decoder/overlayer/encoder can be used.

At block 524, the combined video is outputted.

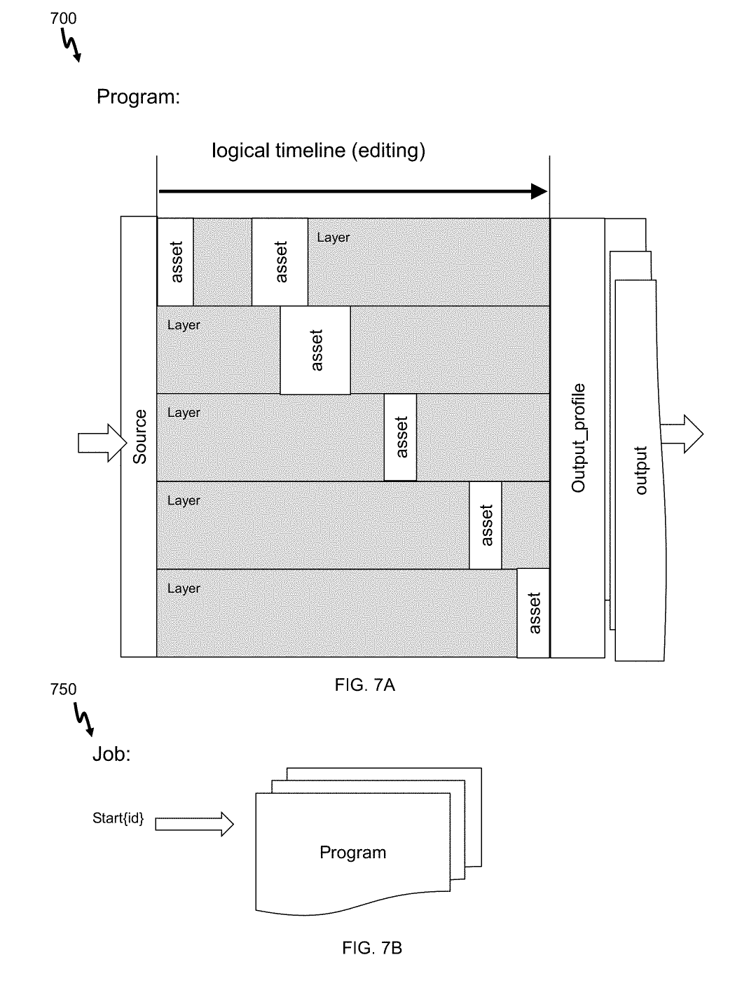

Referring to FIG. 7A, an exemplary diagrammatic program flow 700, using the embodiments described herein, is shown. In this diagram, time is conceptualized as increasing along the x-axis. FIG. 7B illustrates an exemplary diagrammatic job 750, using the embodiments described herein.

In an embodiment, each program includes assets, sources, filters, outputs, and output_profiles.

Each asset can be, for example, an image, a video, an audio clip, or a reference to an HTML, CSS, Javascript, or WebGL animation page.

Each layer being a discrete and/or logical element displayed to a user; for example, an advertisement, a video, an HTML element, or the like. Each layer includes one or more assets. A layer can also include a page, such as an HTML page, which the system can record, render, and/or scrape. The layer can also include metadata describing the layer dimension, duration, or the like. For each of the assets, the layer can include information regarding a starting frame, duration, location, or the like.

The source can be a particular storage location, for example on a cloud-based storage, and access procedure for receiving the data from the source. In some cases, the source can be located on a server database. In other cases, the source can be remote; for example, have a URL location, located on a remote server or computing device, or located a cloud service. In some cases, the source dynamic media data is downloaded to database of the server.

The output_profile is an output profile specifying various parameters of the output stream, for example, codec (for example, one of H264 or H265), format, bitrate (in bits-per-second), width (in pixels), height (in pixels), framerate (in frames-per-second), video container (for example, one of WebM or MP4), and encoder. These parameters can, as an example, be used to generate higher or lower quality outputs; for example, 480p, 720p, or 1080p video resolutions. These parameters are advantageously determined because various users or content hosts can have certain standards of quality they want to use. For example, a content host with mostly user uploaded videos may want to output videos at a lower quality or bitrate in comparison to a content host with professionally produced videos.

Each output video can be a stored or sent to a particular storage location; for example, stored locally on the server or sent to a cloud-based storage.

In a particular case, the program 700 can be a Javascript function with the following parts:
Init( )—for initialization/construction;
Setup( )—can periodically called to do some request or setup some state, and to make HTTP calls;
.Intercept( )—given an origin URL (asset location) and parameters, can determine if this program wants to modify the origin, and make HTTP calls; and
.Process( )—given the origin URL, can return the following:
   Source—from current program workspace;
   Layer—from current program workspace;
   Filters—from current program workspace;
   Outputs—from current program workspace; and
   Filtergraph—is an ffmpeg filtergraph which can be used to layout layers on screen and on timeline.

In a particular case, the job 750 can be can be invoked via URL given an origin URL and parameters. Each job 750 can belong to a workspace and can iterate through programs to find one that will intercept this origin media. Once a program 700 is selected, Process( ) is called to get the resources and filtergraph. Feed this to engine and write output stream to selected outputs. In some cases, each job is logged for analytics and reporting.

Generally, a user submits a job via the input interface 106. The job can contain information regarding a location of the source dynamic media, and in some cases, metadata regarding key-value pairs. The system passes the job to a selected program, as defined above. The system called the program's Intercept( ) function with the job, and the program can return ‘true’ if it is capable of processing the source dynamic media. The program selection criteria can be based on, for example, the job URL or metadata. These criteria or rules can be expressed as Javascript code defined in the Intercept( )function. In a particular case, the rules can include: (1) matching by metadata tags of the source dynamic media against the program; (2) time of day; and the like. In an example of (1), the source dynamic media can have tags such as “girl”, “restaurant”, and “dress”. For a given program, the system can select a shampoo advertisement for insertion into the source dynamic media based on, for example, the tags of “girl”, “fashion”, and “makeup”. In an example of (2), for a given program, the system may only select source dynamic medias based on a time of day, such as 8 pm to 11 pm. These and other rules are contemplated herein.

The system selects a program by iterating through one or more defined programs and passing the job to the Intercept( ) function. In a particular case, the system will select the first program that returns a value of true for that job.

The selection logic can be based on, for example, job data, date, past state, or the like. In the intercept function, various states and/or statistics can be saved by setting a variable that is persisted between invocations. The intercept function can also use this state to direct future decisions.

Once a program has selected a job, the system will call the program's Process( ) function. This determines the various objects, and the system can execute the method 500 described herein. As such, each program can be used on a per-asset-basis in order to insert (such as via an overlay) the asset into the source dynamic media. For each of the assets, insertion rules can be represented by the layer object.

Accordingly, the system 100 can select and place the one or more advertisement assets over the source dynamic media. If the advertisement contains a coded page, a browser, or other software capable of decoding the coded page, is launched with the code of the coded page. The coded page can include, for example, HTML, CSS, Javascript, WebGL, or the like. The visual and audio output of the coded page as decoded by the browser is recorded and transformed into a video. This video can then be inserted into the source dynamic media at an appropriate physical position and time in the source dynamic media's timeline. If the advertisement contains transparent elements, it can be blended over top of the source dynamic media. The source dynamic media and assets are combined and transcoded into a desired video format or codec. The combined video can then be distributed or stored, for example, being uploaded to a video hosting service.

In some cases, the system 100 can obtain the desired assets, and stage each asset at, for example, a temporary location. Each asset can then be aligned in the source dynamic media timeline and aligned to an onscreen location; each asset can also be scaled to an appropriate dimension. The source dynamic media can be of any suitable format, for example, MP4, FLV, WEBM or the like. The source dynamic media can be decoded and filtered, along with the assets, such that they can be decoded. The assets include RGBA video assets, image assets, audio tracks, or the like. With the assets decoded, according to the dimension and location of the defined asset, they can be aligning in the timeline of the source dynamic media accordingly. After each of the frames, or after a suitable number of frames, of the source dynamic media is overlaid or blended with the respective one or more assets, the sequence of frames can be encoded according to a format or codec defined by an output profile; thus generating a combined output video.

Thus, the embodiments described herein can advantageously automatically produce the combined output video that is resistant to blocking by an ad-blocker software due to the integral nature of the advertisement with the source dynamic media. Thus automatic approach is advantageously more efficient and scalable than manual insertion of the advertisement into the source dynamic media. Furthermore, in some cases, advantageously, each advertisement can be customized by HTML, CSS, Javascript, WebGL, or the like.

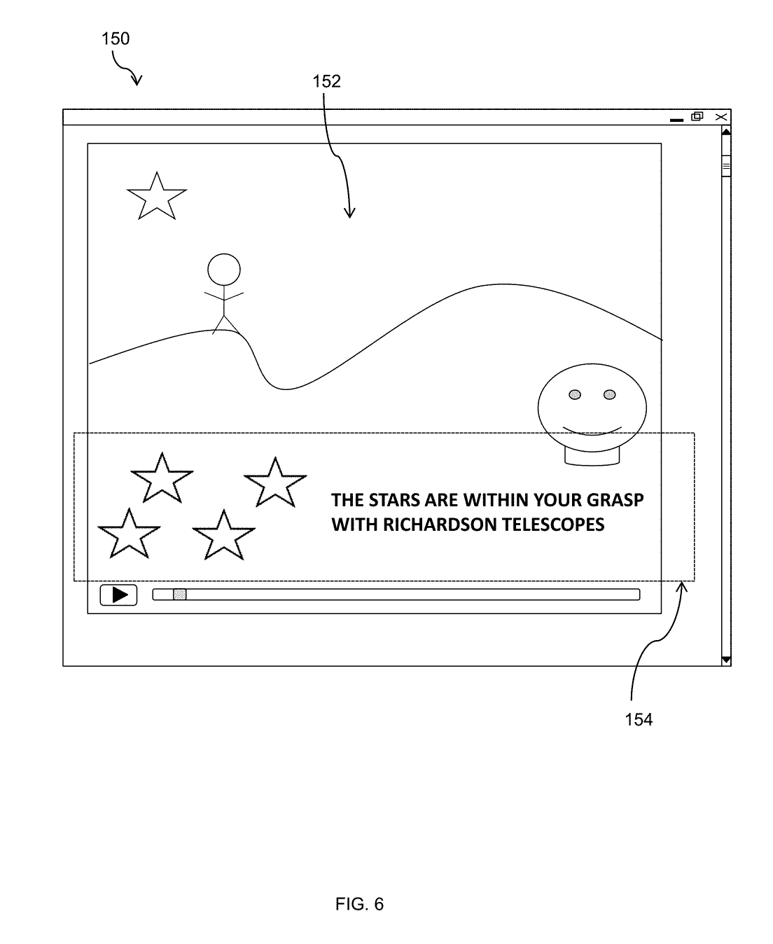

For an exemplary illustration of insertion of an advertisement into a video, an example frame 150 from a video with an inserted advertisement is shown in FIG. 6. An inserted animation 154 (outlined by a dotted line for illustrative purposes) is shown overtop of the source dynamic media 152, with appropriate transparency, such that the rest of the source dynamic media 152 remains unobstructed.

While the above generally describes the source dynamic media as having a video format, the embodiments can use any format as the source dynamic media as long as it is renderable to a sequence of audio and/or video frames. For example, the source dynamic media can be text where such text is renderable text, code, or markup language (such as HTML or JavaScript) to an image or animation composed of sequence of frames. For example, the source dynamic media can be audio; where the audio can be treated as the video above but with only an audio channel and no video stream. For example, the source dynamic media can be one or more images; where such images can be converted to video with repeated frames (one or more images repeated in successive frames). Once the source dynamic media is converted to the desired video format (such as at block 504), then the system 100 can use them as the source dynamic media as described herein.

Though the above has generally been described in relation to advertisements for insertion to a source dynamic media, it should be generally understood that the inserted assets may not be an advertisement and can comprise any suitable media elements; for example, a video, dynamic image, animation, static image, text block, audio track, coded page, or the like.

Although the invention has been described with reference to certain specific embodiments, various modifications thereof will be apparent to those skilled in the art without departing from the spirit and scope of the invention as outlined in the claims appended hereto.

1. A method for automated insertion of one or more assets into a source dynamic media, the method executed on at least one processing unit, the method comprising:
receiving the source dynamic media, the source dynamic media having an associated timeline;
receiving the one or more assets;
determining a media format of each of the one or more assets, the media format comprising at least one of a video component, an audio component, a coded-page component, a text component, and an image component;
converting each of the media formats for each of the one or more assets for compatibility with a dynamic media format of the source dynamic media;
selecting a portion of the timeline for each of the assets;
blending the one or more assets into the source dynamic media during the respective determined portion of the timeline;
encoding the source media and the blended one or more assets as a combined dynamic media; and
outputting the combined dynamic media.

2. The method of claim 1, wherein where the media format comprises a coded-page component, the converting of the media format comprises frame-by-frame conversion into a red green blue alpha (RGBA) format, the alpha channel comprising transparency characteristics.

3. The method of claim 2, wherein the frame-by-frame conversion into the red green blue alpha (RGBA) format comprises:
loading the coded-page in a browser;
operating the browser with a headless configuration in a virtual window;
repeatedly capturing a RGBA image of at least a portion of the elements in the virtual window at a predetermined framerate with any transparent elements captured in the alpha channel; and
saving the RGBA images sequentially as a video file.

4. The method of claim 3, wherein the coded-page comprises at least one of Hypertext Mark-up Language (HTML), Cascading Style Sheets (CSS), JavaScript, and WebGL.

5. The method of claim 1, where the media format of one of the assets comprises a video component, a coded-page component, a text component, or an image component, the method further comprising selecting a screen position for such asset relative to the source dynamic media.

6. The method of claim 1, wherein encoding the source media and the blended one or more assets as the combined dynamic media comprises applying FFMPEG encoding to the source media and the blended one or more assets using a filter graph.

7. The method of claim Error! Reference source not found., wherein blending the one or more assets into the source dynamic media comprises overlaying each of the one or more assets over the source dynamic media at the selected portion of the timeline.

8. The method of claim 7, wherein where the media format of one of the assets comprises an audio component, overlaying such audio component over the audio of the dynamic media.

9. The method of claim Error! Reference source not found., wherein blending the one or more assets into the source dynamic media comprises interspersing each of the one or more assets between portions of the timeline of a corresponding media format of the source dynamic media.

10. The method of claim 7, wherein the one or more assets comprise two or more assets, and wherein overlaying the assets over the source dynamic media comprises:
organizing the assets into a plurality of layers, each layer comprising one or more assets;
assigning a layer order to the plurality of layers; and
overlaying the assets over the source dynamic media in an order that is based on the layer order.

11. A system for automated insertion of one or more assets into a source dynamic media, the system comprising at least one processing unit and a data storage, the at least one processing unit in communication with the data storage and configured to execute:
an obtainment module to receive into the data storage the source dynamic media, the source dynamic media having an associated timeline, and receive into the data storage the one or more assets;
a coding module to determine a media format of each of the one or more assets, the media format comprising at least one of a video component, an audio component, a coded-page component, a text component, and an image component, and convert each of the media formats for each of the one or more assets for compatibility with a dynamic media format of the source dynamic media; and
an output module to select a portion of the timeline for each of the assets, blend the one or more assets into the source dynamic media during the respective determined portion of the timeline, encode the source media and the blended one or more assets as a combined dynamic media, and output the combined dynamic media.

12. The system of claim 10, wherein where the media format comprises a coded-page component, the converting of the media format comprises frame-by-frame conversion into a red green blue alpha (RGBA) format, the alpha channel comprising transparency characteristics.

13. The system of claim 12, wherein the frame-by-frame conversion into the red green blue alpha (RGBA) format comprises:
loading the coded-page in a browser;
operating the browser with a headless configuration in a virtual window;
repeatedly capturing a RGBA image of the virtual window at a predetermined framerate with any transparent elements captured in the alpha channel; and
saving the RGBA images sequentially as a video file.

14. The system of claim 13, wherein the coded-page comprises at least one of Hypertext Mark-up Language (HTML), Cascading Style Sheets (CSS), JavaScript, and WebGL.

15. The system of claim 11, where the media format of one of the assets comprises a video component, a coded-page component, a text component, or an image component, the output module further selects a screen position for such asset relative to the source dynamic media.

16. The system of claim 10, wherein encoding the source media and the blended one or more assets as the combined dynamic media comprises applying FFMPEG encoding to the source media and the blended one or more assets using a filter graph.

17. The system of claim 10, wherein blending the one or more assets into the source dynamic media comprises overlaying each of the one or more assets over the source dynamic media at the selected portion of the timeline.

18. The system of claim 17, wherein where the media format of one of the assets comprises an audio component, overlaying such audio component over the audio of the dynamic media.

19. The system of claim 10, wherein blending the one or more assets into the source dynamic media comprises interspersing each of the one or more assets between portions of the timeline of a corresponding media format of the source dynamic media.

20. The system of claim 17, wherein the one or more assets comprise two or more assets, and wherein overlaying the assets over the source dynamic media comprises:
organizing the assets into a plurality of layers, each layer comprising one or more assets;
assigning a layer order to the plurality of layers; and
overlaying the assets over the source dynamic media in an order that is based on the layer order.
